(19) United States
(12) Patent Application Publication
(10) Pub. No.: US 2010/0137041 A1
(43) Pub. Date: Jun. 3, 2010

(54) SLIDING ROTATING APPARATUS

(76) Inventor: Han Sang Lee, Seoul (KR)

Correspondence Address: OSTROLENK FABER GERB & SOFFEN, 1180 AVENUE OF THE AMERICAS, NEW YORK, NY, 100368403, US

(21) Appl. No.: 12/597,573

(22) PCT Filed: May 7, 2008
(86) PCT No.: PCT/KR2008/002564

§ 371 Date: Oct. 26, 2009

(30) Foreign Application Priority Data
May 9, 2007 (KR) 10-2007-0045163

(51) Int. Cl. F16H 21/50; H04W 88/02

(52) U.S. Cl. 455/575.4; 74/44

(57) ABSTRACT

Disclosed is a pivot apparatus having a pivot member adapted so that, when pivoted to the service angle, it slides to the service position while interlocking with the pivot movement and is set in the service condition. To this end, a link interlocks the pivot movement based on the pivot structure with the sliding movement based on the siding structure. Particularly, the sliding structure is applied to the coupling between the support and sliding members, and the pivot structure is applied to the sliding and pivot members to pivotably couple them to each other. The link connects the support and sliding members so that, as the pivot member pivots relative to the sliding member by means of the user's pivot force, the sliding member slides to the desired direction and distance from the support member while interlocking with the pivot movement. As a result, the pivot member slides while interlocking with the pivot movement.

### TECHNICAL FIELD

The present invention relates to an apparatus having a pivot member adapted so that, when pivoted to the service angle, the pivot member slides to the service position concurrently with the pivot movement to be set in the service condition. More particularly, the present invention relates to a sliding pivot apparatus having sliding and pivot structures interlocked with each other by a link to interlock the sliding movement of the pivot member with its pivot movement so that the corner of the pivot member does not interfere with the adjacent support member while pivoting along the radius of rotation, and that the pivot member is moved as much as the desired distance concurrently with a change of direction, thereby setting the pivot member in the desired direction and service position by a single operation.

### BACKGROUND ART

As generally known in the art, portable terminals, e.g. cellular phones, are continuously evolving into various types, including flip-type, bar-type, and folder-type phones. In addition, sliding-type cellular phones have recently appeared on the market and are widely used.

Recent cellular phones incorporate a photography function and a moving picture watching function. As a result, cellular phones are expected to enable users to freely rotate the cover so that they can position the liquid crystal screen on the cover in the transverse or longitudinal direction and watch still or moving pictures conveniently or take pictures at a desired angle. For example, recent trends toward enhanced support for moving picture services, e.g. DMB (Digital Multimedia Broadcasting) service, by cellular phones are followed by the appearance of products enabling users to conveniently watch moving pictures from screens positioned in the transverse direction. To this end, cellular phones are equipped with a pivot mechanism so that the cover can pivot relative to the body to be positioned in the transverse direction. Such a pivot mechanism is also applied to folder-type or slide-type cellular phones so that the cover on the body can pivot relative to the body.

The conventional mechanism for pivoting the cover of folder-type cellular phones couples the body and the cover based on both an open shaft structure and a pivot shaft structure so that the cover can pivot about the pivot shaft relative to the body. This folder-type pivot structure has a problem in that, since the coupling is based on a shaft having a small diameter, the cover is supported by insufficient force. This means that the cover can be easily damaged by external force. Furthermore, the pivot member is coupled only by the pivot shaft, and this structure cannot support the cover stably after it has been pivoted by the pivot mechanism. As a result, the cover in a stationary position may be moved or vibrated even by weak external impact. After the cover has been used repeatedly, the clearance between components of the pivot shaft increases, which means that the cover is not supported firmly and tends to play.

In order to solve the fundamental problem of the above-mentioned pivot shaft structure, it has been proposed that the pivot mechanism consist of a dual-plate structure, i.e. a cover support plate unit for coupling the cover to the body while being able to open/close and a pivot member coupled so as to pivot relative to the cover support plate unit, and that the cover support plate unit support a lateral surface of the pivot member, besides the pivot shaft structure of the cover support plate unit and the pivot member. However, this structure has the following problems. Opposite edges of the pivot member must be curved smoothly based on consideration of the radius of rotation so that, when the pivot member is pivoted, the corner of the pivot member does not interfere with the seating surface of the cover support plate unit that supports a lateral surface of the pivot member. Alternatively, the pivot member must be pulled away from the cover support plate unit so that it is spaced from the seating surface, before the pivot member is pivoted. Consequently, the former case restricts the design of conventional cellular phones, the overall shape of which is rectangular, with only corners being curved. In the latter case, the pivot movement requires both moving and rotating operations by the user, and is both inconvenient and difficult. When pivoted to the transverse direction, the pivot member, a surface of which has been forced against the seating surface of the cover support plate unit in the longitudinal direction, is spaced from the seating surface as much as the difference between the transverse and longitudinal distances from the center of rotation of the pivot member. This makes the supporting force unstable. Therefore, for the sake of stable support, the pivot member must be forced against the seating surface again after it has been pivoted to the transverse direction.

Meanwhile, sliding-type cellular phones have a pivot mechanism in addition to the sliding mechanism so that, when the cover is to be pivoted relative to the body, the cover is slid upward to expose the keypad portion on the body, which has been covered with the cover, and then pivoted. This means that two types of operations must be conducted successively as in the case of the above-mentioned folder type, which is inconvenient and requires much operation force. This is contrary to the consumer's request for a higher level of convenience. Once pivoted, furthermore, the cover is supported only by the pivot shaft, and may be turned or vibrated even by weak external impact. rotation as much as a predetermined angle by the user's pivot operation, but can neither correct nor adjust the position accordingly. As a result, the user must additionally move the pivot member in an inconvenient manner to correct the position of the pivot member and avoid interference during the pivot movement, or to move it to a position in which it can be operated conveniently.

### DISCLOSURE OF INVENTION

### Technical Problem

Therefore, the present invention has been made in view of the above-mentioned problems, and the present invention provides a sliding pivot apparatus having a pivot member, the sliding movement of which is interlocked with the pivot movement so that, by moving the pivot member a predetermined distance concurrently with a change of direction, the pivot member is conveniently operated in the desired direction and service position.

The present invention also provides a sliding pivot apparatus having a pivot member adapted so that, once pivoted by the user, it slides away from the support surface of the support member, which supports a lateral surface of the pivot member, while interlocking with the pivoting movement, and so that the corner of the pivot member freely rotates along the radius of rotation without interfering with the support member that supports the pivot member.

### Technical Solution

In accordance with an aspect of the present invention, there is provided a sliding pivot apparatus including a support member; a sliding member slidably coupled to the support member; a pivot member pivotably coupled to the sliding member; and a link having a first end rotatably coupled to the pivot member and a second end rotatably coupled to the support member so that, as the pivot member pivots, the first end coupled to the pivot member pivots about a point coupled to the support member and displaces the pivot member.

In accordance with another aspect of the present invention, there is provided a sliding pivot apparatus including a support member; a sliding member slidably coupled to the support member; a pivot member having a through-hole; a rotation plate having a first end coupled to the sliding member via the through-hole and a second end provided with an engaging ledge for engaging with a periphery of the through-hole of the pivot member so that the pivot member and the sliding member are pivotably coupled to each other; and a link having a first end rotatably coupled to the pivot member and a second end rotatably coupled to the support member so that, as the pivot member pivots, a pivot end coupled to the pivot member pivots about a point coupled to the support member and displaces the pivot member in a direction.

Preferably, when the pivot member is positioned in a longitudinal direction, the link is biased toward a destination of movement of the pivot member from a pivot center of the pivot member and is positioned in a half region in a pivot direction of the pivot member with reference to a vertical center line extending through the pivot center of the pivot member.

The pivot member has a rectangular shape with different longitudinal and transverse ratios, and is adapted to reciprocate between a first position in a longitudinal direction and a second position in a transverse direction while conducting interlocked pivot and sliding movements. A line segment leading from the pivot center to the pivot end of the link is joined with a line segment leading from the pivot end to the fixed end of the pivot member at an obtuse angle in the first position, and the obtuse angle is gradually decreased by a pivot movement of the pivot member from the first position to the second position.

In accordance with another aspect of the present invention, there is provided a sliding pivot apparatus including a support member; a sliding member slidably coupled to the support member; a pivot member having a through-hole; a rotation plate having a first end coupled to the sliding member via the through-hole and a second end provided with an engaging ledge for engaging with a periphery of the through-hole of the pivot member so that the pivot member and the sliding member are pivotably coupled to each other; and a link having a first end rotatably coupled to the pivot member and a second end rotatably coupled to the support member so that, as the pivot member pivots, a pivot end coupled to the pivot member pivots about a point coupled to the support member in a direction opposite to a pivot direction of the pivot member to displace the pivot member in a direction and, after a change of direction, displaces the pivot member in the opposite direction.

The pivot member has a rectangular shape with different transverse and longitudinal ratios and is adapted to reciprocate between a first position in a longitudinal direction and a second position in a transverse direction while conducting interlocked pivot and sliding movements. The link is biased toward a destination of movement of the pivot member from the pivot center of the pivot member when the pivot member is in the first position, and the pivot end of the link is positioned past a vertical line extending through the coupling point of the support member in parallel with a vertical center line extending through the pivot center of the pivot member in a direction opposite to the pivot direction of the link.

In accordance with another aspect of the present invention, there is provided a sliding pivot apparatus including a support member; a sliding member slidably coupled to the support member and provided with a through-hole; a rotation plate having a first end coupled to the pivot member via the through-hole and a second end provided with an engaging ledge for engaging with a periphery of the through-hole of the sliding member so that the pivot member and the sliding member are pivotably coupled to each other; a pivot member coupled to the first end of the rotation plate and adapted to slide while rotating as an integral unit with the rotation plate; and a link having a first end rotatably coupled to the rotation plate and a second end rotatably coupled to the support member so that, as the pivot member pivots, a pivot end coupled to the pivot member pivots about a point coupled to the support member in a direction opposite to a pivot direction of the pivot member to slide the sliding member in a direction and, after a change of direction, slides the sliding member in the opposite direction.

### Advantageous Effects

As mentioned above, the sliding pivot apparatus according to the present invention is advantageous in that the pivot member, which is adapted to pivot relative to the support member, slides while interlocking with the pivot movement so that, by moving the pivot member a predetermined distance concurrently with a change of direction, the pivot member is conveniently operated in the desired direction and service position.

If the user pivots the pivot member, the pivot member slides away from the support surface of the support member, which supports a lateral surface of the pivot member, while interlocking with pivoting movement. As a result, the corner of the pivot member freely rotates along the radius of rotation without interfering with the support member that supports the pivot member.

By applying the present invention to an electronic application device (e.g. a cellular phone, an LCD monitor, a PDA), the user has only to pivot the pivot unit, which includes a screen, relative to the support unit so that the pivot unit slides to the desired service position while interlocking with the pivot movement.

The inventive apparatus uses a spring to easily realize pivot and sliding movements with little operation force. In addition, the apparatus adopts a plate-based pivot coupling structure, not shaft-based coupling, to obtain stable a coupling structure and excellent durability. The interlocking between the pivot and sliding structures according to the present invention (i.e. the sliding movement is interlocked with the pivot movement) can be applied to a wide range of fields requiring similar types of movements. Particularly, when applied to a cellular phone, the display screen moves to the desired height as soon as it is pivoted to be watched in the transverse position. This improves user convenience and stability.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is an assembled perspective view of a sliding pivot apparatus according to a first embodiment of the present invention;

FIG. 2 is an exploded perspective view of the apparatus shown in FIG. 1;

FIG. 3 is an exploded perspective view of the apparatus shown in FIG. 2 when viewed from below;

FIG. 4 is an assembled perspective view showing a part of the apparatus shown in FIG. 2;

FIG. 5 is a perspective view showing a method for operating and using the apparatus shown in FIGS. 1-4 as an example of application of structure of the apparatus to a cellular phone;

FIG. 6 shows the operation process of the internal operation mechanism of the apparatus shown in FIG. 5;

FIG. 7 shows the movement trajectory of the pivot member and the link during a pivot operation;

FIG. 8 is an assembled perspective view of a sliding pivot apparatus according to a second embodiment of the present invention;

FIG. 9 is an assembled perspective view showing a part of the apparatus shown in FIG. 8 after removing the support member to reveal the internal structure;

FIG. 10 is an exploded perspective view of the apparatus shown in FIG. 8;

FIG. 11 is an exploded perspective view of the apparatus shown in FIG. 10 when viewed from below;

FIG. 12 is a perspective view showing a method for operating and using the apparatus shown in FIGS. 8-11;

*FIG. 13 shows the operation process of the internal operation mechanism in connection with the method shown in FIG. 12;

FIG. 14 shows the movement trajectory of the pivot member and the link during a pivot operation;

FIG. 15 shows an example of application of the structure according to the second embodiment of the present invention to a cellular phone;

FIG. 16 is an assembled perspective view of a sliding pivot apparatus according to a third embodiment of the present invention;

FIG. 17 is an exploded perspective view of the apparatus shown in FIG. 16;

FIG. 18 is an exploded perspective view of the apparatus shown in FIG. 17 when viewed from below;

FIG. 19 is an assembled perspective view separately showing a part of the apparatus shown in FIG. 16;

FIG. 20 is a perspective view showing a method for operating and using the apparatus shown in FIGS. 16-19;

FIG. 21 is a top view of the operation mechanism in connection with the method shown in FIG. 20;

FIG. 22 is an assembled perspective view of a sliding pivot apparatus according to a fourth embodiment of the present invention;

FIG. 23 is an exploded perspective view of the apparatus shown in FIG. 22;

FIG. 24 is an exploded perspective view of the apparatus shown in FIG. 23 when viewed from below;

FIG. 25 shows a method for operating and using the apparatus shown in FIGS. 22-24; and

FIGS. 26 and 27 show examples of a passage formed on the support member according to embodiments of the present invention.

### BEST MODE FOR CARRYING OUT THE INVENTION

Hereinafter, exemplary embodiments of the present invention will be described with reference to the accompanying drawings.

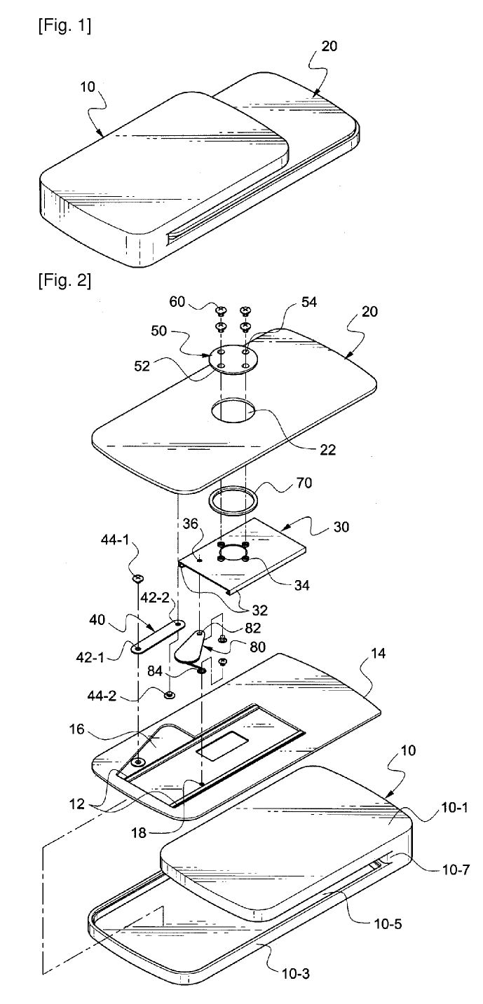

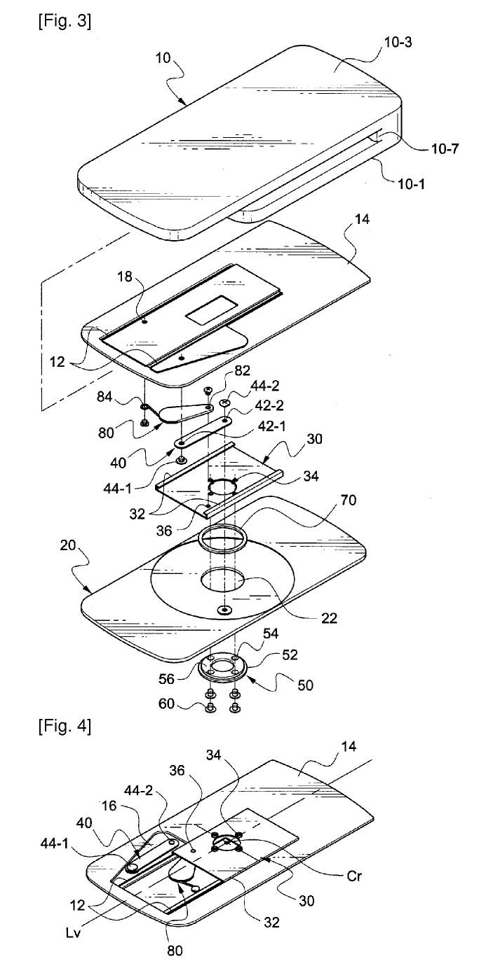

FIG. 1 is an assembled perspective view of a sliding pivot apparatus according to a first embodiment of the present invention. FIG. 2 is an exploded perspective view of the apparatus shown in FIG. 1. FIG. 3 is an exploded perspective view of the apparatus shown in FIG. 2 when viewed from below. FIG. 4 is an assembled perspective view showing a part of the apparatus shown in FIG. 2.

The apparatus according to the present invention has pivot and sliding structures interlocked with each other so that, when the pivot member 20 pivots relative to the support member 10, the pivot member 20 slides a predetermined distance while interlocking with the pivot movement.

To this end, the pivot member 20 is coupled to the support member 10 via a sliding member 30, as shown in the drawings. Particularly, the sliding member 30 is slidably coupled to the support member 10, and the pivot member 20 is pivotably coupled to the sliding member 30. The pivot member 30 and the support member 10 are connected to each other by a link 40 to interlink the three members 10, 20, and 30 in such a manner that the sliding movement of the sliding member 30 is interlocked with the pivot movement of the pivot member 20.

The support member 10 and the sliding member 30 are slidably coupled to each other by a sliding structure. According to a coupling method, a straight guide hole 12 is formed on the support member 10, and a coupling ledge 32 of the sliding member 30 is coupled to the guide hole 12 so that, as the coupling ledge 32 slides along the guide hole 12, the sliding member 30 can slide on the support member 10. Preferably, a pair of guide holes 12 and a pair of coupling ledges 32 are formed on the left and right sides of the support member 10 and the sliding member 30, respectively, as shown in the drawings according to the present embodiment. Particularly, a pair of (left and right) guide holes 12 may be integrally formed on the support member 10. Alternatively, the guide holes 12 may be formed on a separate support plate 14, which is coupled to the support member 10.

Other types of sliding structures may also be used, such as one including a guide bar (not shown) and a guide hole (not shown) fitted and coupled to the guide bar, as long as the support member and the sliding member can slide relative to each other.

The pivot coupling structure between the sliding member 30 and the pivot member 20 will now be described. The pivot member 20 has a through-hole 22 formed thereon, and a rotation plate 50 having an engaging ledge 52 is fitted into the through-hole 22 to couple the pivot member 20 to the sliding member 30. Particularly, the rotation plate 50 is fitted into the through-hole 22 in such a manner that the engaging ledge 52 engages with the periphery of the through-hole 22 of the pivot member 20, and that one end of the rotation plate 50 extends through the through-hole 22 and couples to the sliding member 30. According to a more preferred coupling method, a number of bolt holes 54 are formed on the rotation plate 50, and bolts 60 are fitted into the bolt holes 54 and fastened to fastening holes 34 of the sliding member 30, which are connected to the bolt holes 54. The engaging ledge 52 of the rotation plate 50 preferably has a circular shape. The engaging ledge 52 does not extend through the through-hole 22, but engages with the pivot member 20, and a shaft plate portion 56 of the rotation plate 50 passes through the through-hole 22 to be forced against and coupled to the sliding member 30. As a result, the pivot member 20 is coupled to the sliding member 30 while being able to pivot relative to the sliding member 30. A lubricating member 70 is preferably interposed between the sliding member 30 and the pivot member 20 to reduce friction and wear during rotation of both members and guarantee a smooth pivot movement. The lubricating member 70 has an annular shape, and is fitted to the shaft plate portion 56 of the rotation plate 50. The lubricating member 70 is preferably made of plastic or metal.

The link 40 is the most important component of the apparatus, which transmits the pivot force of the pivot member 20 caused by external force to the sliding member 30 as force necessary for its straight sliding movement. One end of the link 40 is rotatably coupled to the support member 10, and the other end thereof is rotatably coupled to the pivot member 20. Particularly, the link 40 has the shape of a straight bar, and has pin holes 42-1 and 42-2 on both ends. A coupling pin 44-1 is inserted into the pin hole 42-1 on one end so that the end is rotatably coupled to the support plate 14, which is fixed to the support member 10. A coupling pin 44-2 is inserted into the pin hole 42-2 on the other end so that the other end is rotatably coupled to the pivot member 20. As a result of this coupling, the other end of the link 40 pivots about the end, which is coupled to the support member 10, as a pivot axis. Hereinafter, the end of the link 40 coupled to the support member 10 will be referred to as a fixed end, and the other end coupled to the pivot member 20 will be referred to as a pivot end. The link 40 is positioned toward the direction of sliding movement with reference to the pivot center of the pivot apparatus, and is arranged so that, if the pivot center is joined with both rotation centers of the link (i.e. centers of both pin holes), they constitute an obtuse triangle. Preferably, the line segment leading from the pivot center to the pivot end of the link is joined with the line segment leading from the pivot end of the link to the fixed end of the link at an obtuse angle. The length and angle of movement of the link 40 are designed so that, once the pivot member 20 is rotated by a desired angle, it reaches a desired distance. For example, the length and angle of movement of the link 40 are determined so that, if the pivot member 20 is rotated by 90°, it slides a predetermined distance (from the starting point to the destination) while interlocking with the 90° rotation. In addition, the link 40 is biased toward the direction of rotation with reference to a vertical center line Lv extending through the pivot center Cr of the pivot member 20.

The link 40 is made of rigid metal or plastic capable of resisting operation force and providing the pivot member 20 with force for straight movement. Preferably, the link 40 has the shape of a thin bar, and the support plate 14 is provided with a link receiving recess 16 for receiving the link 40 and defining space that guarantees stable movement of the link 40.

According to the present embodiment, the support member 10 includes a front plate portion 10-1 and a rear plate portion 10-3 connected to one end of the front plate portion 10-1. The front plate portion 10-1 has a small height, while the rear plate portion 10-3 has a large height so that a portion of the rear plate portion 10-3 does not overlap the front plate portion 10-1 to be exposed. In addition, the overlapping portions of the front and rear plate portions 10-1 and 103 are spaced from each other to define a receiving space 15-5, into which the pivot member 20 can enter. A lateral surface of the pivot member 20 is supported inside the connection portion 10-7, which connects the front and rear plate portions 10-1 and 10-3 to each other. Therefore, when the pivot member 20 is positioned in the longitudinal direction (first position), the pivot member 20 is folded on the rear plate portion 10-3 of the support member 10 and is placed in the receiving space 10-5 of the support member 10. The lower end of the pivot member 20 is forced against the inner surface (support surface) of the connection portion 10-7 so that the pivot member 20 does not easily move out of the support member 10. If the pivot member 20 is pivoted in this condition, it escapes from the receiving space 10-5 and rotates up to 90° so that it is positioned in the transverse direction, i.e. in a direction approximately perpendicular to the rear plate portion 10-3 (second position). The lower end of the pivot member 20 may interfere with the inner surface of the connection portion 10-7, which supports the lower end of the pivot member 20 during such a pivot movement. Such interference is prevented by the apparatus according to the present invention in the following manner: if the pivot member 20 is pivoted, it gradually slides and ascends concurrently with the pivot movement so that the inflection point of the lower corner of the pivot member 20 does not engage with the inner surface (support surface) of the connection portion 10-7. In addition, the pivot member 20 further slides upward as it is pivoted until it stops pivoting and reaches the operation position. As a result, the pivot member 20 both pivots and ascends so that it escapes from the receiving space 10-5 of the support member 10 and gets ready to be used (i.e. exposed in the transverse direction).

The apparatus is also equipped with a spring 80 for facilitating the pivot and sliding movements. The spring 80 is installed between the support member 10 and the sliding member 30 to multiply the operation force during the pivot and sliding operations. To this end, one end of the spring 80 is coupled to the support member 10, and the other end thereof is coupled to the sliding member 30. Preferably, the coupling positions of both ends of the spring 80 are on a diagonal line with reference to the sliding direction (one above, the other below) so that restoration force properly acts on the sliding member 30. The spring 80 is compressed as much as about half the sliding distance of the sliding member 30, and after half the sliding distance is exceeded, the compression force is converted into restoration force and facilitates the sliding. In other words, in the course of the pivot movement of the pivot member 20 caused by external force, the spring 80 undergoes extension, compression, and extension again, and provides the sliding member 30 with restoration force, which is created during conversion from the compression to extension, to complete the sliding movement of the sliding member 30 and the pivot movement of the pivot member 20. As such, the spring 80 enables the user to easily pivot and slide the pivot member 20 to the destination with little force. The spring 80 preferably consists of a link-type spring as shown in the drawings. One end 82 of the link-type spring 80 is rotatably connected to a hole 36 of the sliding member 30, and the other end 84 thereof is rotatably connected to a hole 18 of the support member 10.

Besides the exemplary link-type spring, the present invention may use other types of springs 80, including a torsion spring, a coil spring, and a leaf spring.

*The support surface of the connection portion 10-7 of the support member 10 may be also an interfered portion formed on other component while the pivot member 20 pivots. According to the present invention, the pivot member 20 is adapted to pivot and slide away from the support surface, which would otherwise interfere with other components and hinder the rotation. Furthermore, the pivot member 20 is moved to the desired service position concurrently with the pivot movement.

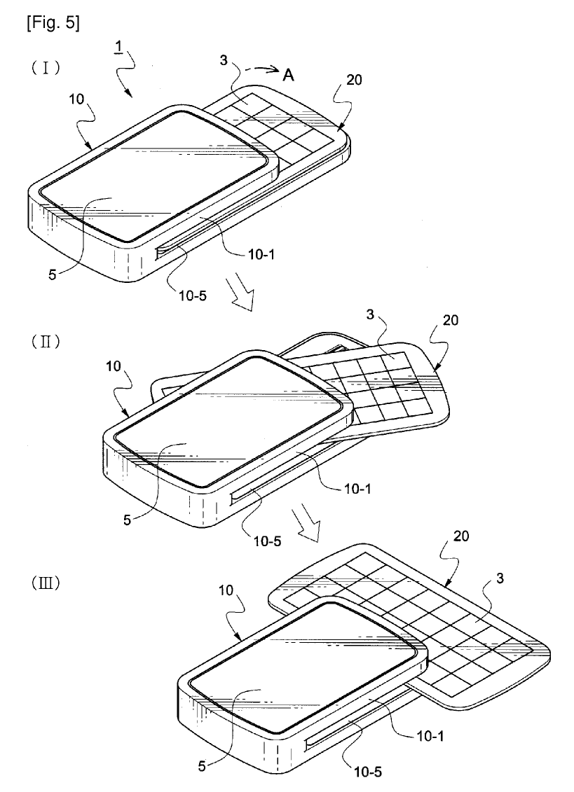

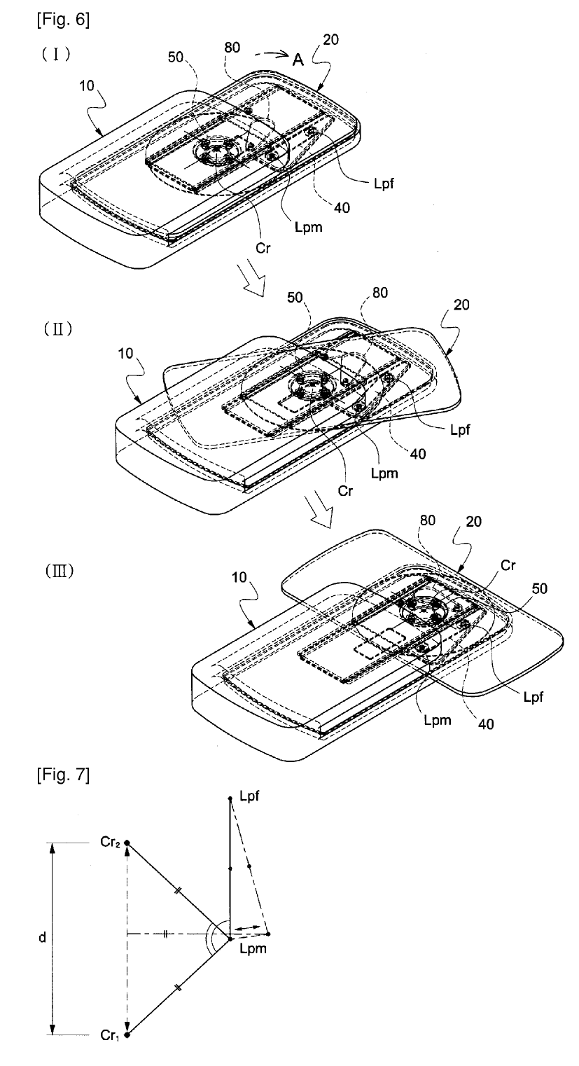

FIG. 5 is a perspective view showing a method for operating and using the apparatus shown in FIGS. 1-4 as an example of application of structure of the apparatus to one of application devices, i.e. a cellular phone. FIG. 6 shows the operation process of the internal operation mechanism of the apparatus shown in FIG. 5. FIG. 7 shows the movement trajectory of the pivoting member and the link during a pivot operation. Particularly, circular dots in FIG. 7 indicate the movement trajectory of the pivot end of the link, and lozenge dots indicate the movement trajectory of the pivot center of the pivot member. The principle of operation of the cellular phone, to which the structure according to the first embodiment of the present invention has been applied, will now be described with reference to these drawings.

The first embodiment of the present invention is useful for a cellular phone 1 having a QWERTY keyboard with many keys, as show in FIG. 5. It can be assumed in this case that the pivot member 20 is provided with a QWERTY keyboard 3, and that the front plate portion 10-1 of the support member 10 is provided with a liquid crystal screen 5. Then, the support member 10 constitutes the body of the cellular phone 1, and the pivot member 20 acts as the keypad. Although not shown in the drawings, it is also possible to install a general keypad on the front plate portion 10-1 of the support member 10 and provide the pivot member 20 with the liquid crystal screen. In the following description of the present embodiment, which uses the support member and the pivot member as the body and the keypad, respectively, the same reference numerals of the support member and the pivot member will be used for the corresponding body and keypad, respectively.

When such a cellular phone application device is not used, the keypad 20 is folded into the receiving space 10-5 of the body 10, as shown in (I) of FIG. 6. If the user wants to use the keypad 20 in this condition, he/she pushes the upper portion of the keypad 20, which is exposed from the body 10, in direction A by hand. Then, the keypad 20 pivots about the rotation plate 50 as the pivot axis. As a result, the coupling point Lpm between the pivot end of the link 40 and the keypad 20 rotates and descends when viewed from the keypad 20, as shown in (II) of FIG. 6. However, the fixed end of the link 40, which is fixed to the body 10, prevents the keypad 20 from descending. Therefore, the downward displacement of the coupling point Lpm of the keypad 20 in turn lifts the keypad 20. It can be said that, when viewed from the link 40, the coupling point Lpm moves within the horizontal amplitude as the keypad 20 pivots 90°. Therefore, the coupling point Lpm of the pivot end of the link 40 reciprocates within that range about the coupling point Lpf of the fixed end. As a result, if the keypad 20 is rotated 90° from the longitudinal direction (first position) and is positioned in the transverse direction (second position), the coupling position Lpm between the link 40 and the keypad 20, which has been lying above the pivot center Cr, moves below the pivot center Cr, as shown in (III) of FIG. 6, so that the keypad 20 is lifted as much as the vertical sliding distance. In other words, the pivot center of the keypad 20 moves as much as the vertical distance d from the initial pivot position Cr1 to the final pivot position Cr2. In summary, the keypad 20 ascends as much as the vertical distance d concurrently with pivoting 90° relative to the body 10, and is positioned in the transverse direction.

As such, the keypad 20 slides concurrently with pivoting until it is exposed from the body 10 to be used. Then, the user can operate the keypad 20, which is positioned in the transverse direction, to make a call or input characters.

After the call is over, the keypad 20 is folded into the body 10 in the reverse of the process of unfolding the keypad 20.

### Mode for the Invention

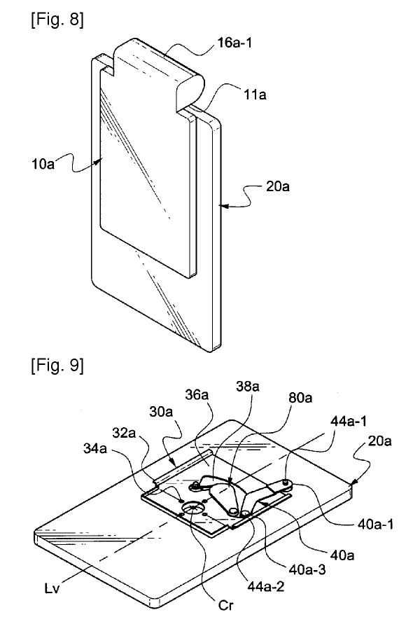

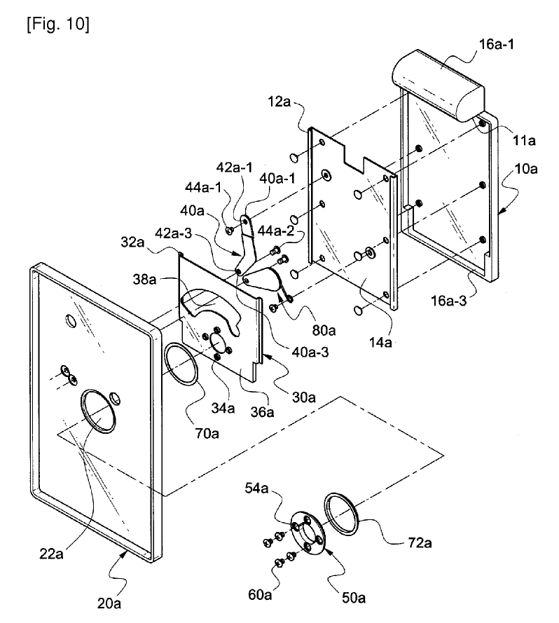

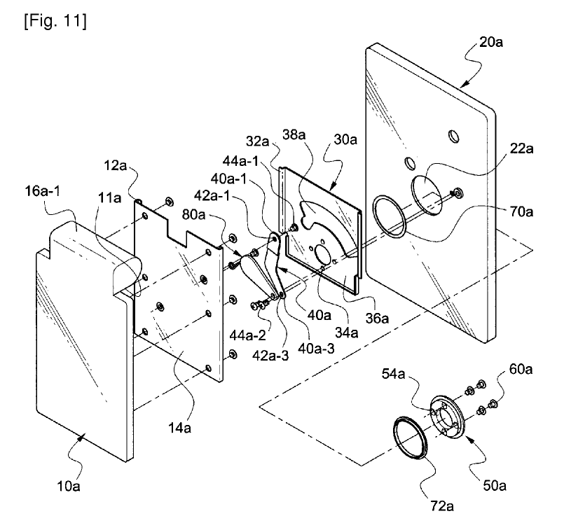

FIG. 8 is an assembled perspective view of a sliding pivot apparatus according to a second embodiment of the present invention. FIG. 9 is an assembled perspective view showing a part of the apparatus shown in FIG. 8 after removing the support member to reveal the internal structure. FIG. 10 is an exploded perspective view of the apparatus shown in FIG. 8. FIG. 11 is an exploded perspective view of the apparatus shown in FIG. 10 when viewed from below.

The sliding pivot apparatus according to the second embodiment of the present invention is adapted to realize a series of sliding movements interlocked with the pivot movement in the following manner. When the pivot member 20a, which has been positioned in the longitudinal direction (first position), is pivoted, the pivot member 20a slides away from the support surface 11a of the support member 10a by a distance enough to prevent the corner (inflection point) of the pivot member 20a from interfering with the support surface 11a. After the inflection point has passed, the sliding direction is changed. That is, the pivot member 20a begins to slide toward the support surface 11a while continuously pivoting. After being positioned in the transverse direction (second position), the pivot member 20a is seated on the support surface. The pivot member 20a has a rectangular shape (i.e. the longitudinal and transverse ratios are different) so that it switches between the longitudinal and transverse directions as it is pivoted 90°. Furthermore, the pivot member 20a slides while interlocking with the pivot movement so that it is positioned at the desired height. The pivot member 20a is not necessarily seated on the support surface 11a after it has been moved to the desired height, and the pivot member 20a may slide up to any position. The mechanism of the apparatus will now be described in more detail.

As shown, the apparatus has a sliding member 30a slidably coupled to the support member 10a. To this end, a guide rail 12a and a guide ledge 32a are formed in corresponding portions of the support member 10a and the sliding member 30a, respectively, so that the guide ledge 32a engages with the guide rail 12a and slides along it. Preferably, a pair of sliding structures are provided on the left and right sides, respectively. As exemplified in the drawings, the support member 10a has a pair of guide rails 12a formed on the left and right sides of a surface, and the sliding member 30a has a pair of guide ledges 32a on the left and right sides. More preferably, a pair of guide rails 12a are formed on the left and right sides of the support plate 14a to be fixed to the support member 10a. The guide ledges 32a are bent toward the guide rails 12a from both edges of the plate body portion 36a of the sliding member 30a to engage with the guide rails 12a, respectively.

Engaging ledges 16a-1 and 16a-3 are formed on a surface of the support member 10a, to which the support plate 14a is fixed, at both sliding limits (upper and lower limits) so that the guide ledges 32a, which engage with the guide rails 12a, do not escape from the guide rails 12a. In other words, the guide ledges 32a engage with the engaging ledges 16a-1 and 16a-3 at the sliding limits and do not escape. This prevents the support member 10a and the sliding member 30a from detaching from each other. One of the engaging ledges 16a-1 and 16a-3 on both limits may be replaced with a seating portion 16a-1 provided with a support surface 11a. In this case, a surface of the pivot member 20a is forced against the inner surface of the seating portion 16a-1 so that the inner surface acts as the support surface 11a on which the pivot member 20a is seated. The sliding distance can be adjusted by forming the guide ledges 32a only in a predetermined section from the plate body portion 36a.

The pivot structure for pivotably coupling the pivot member 20a to the sliding member 30a is similar to that of the previous embodiment. That is, a through-hole 22a is formed on the pivot member 20a, and a rotation plate 50a having an engaging ledge 52a is fitted to the through-hole 22a to couple the pivot member 20a to the sliding member 30a. Preferably, an annular lubricating member 72a is interposed into the through-hole 22a to reduce friction and wear between the rotation plate 50a and the sliding member 30a, and a lubricating member 70a is interposed between contact portions of the pivot member 20a and the sliding member 30a to facilitate the pivot movement.

The apparatus has a link 40a, the sliding movement of which is interlocked with (i.e. depends on) the pivot movement of the pivot member 20a. The link 40a is the core component of the apparatus for constraining the pivot member 20a to the support member 10a so that a straight movement occurs depending on the pivot movement. One end of the link 40a is rotatably coupled to the support member 10a, and the other end is rotatably coupled to the pivot member 20a. Particularly, the link 40a has pin holes 42a-1 and 42a-3 on both ends. A coupling pin 44a-1 is inserted into the pin hole 42a-1 on one end so that the end is rotatably coupled to the support plate 14a of the support member 10a, and a coupling pin 44a-2 is inserted into the pin hole 42a-3 on the other end so that the other end is rotatably coupled to the pivot member 20a.

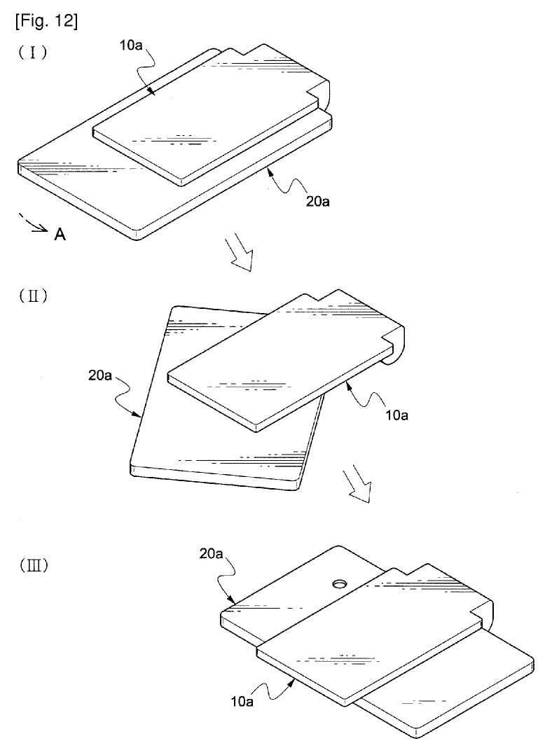

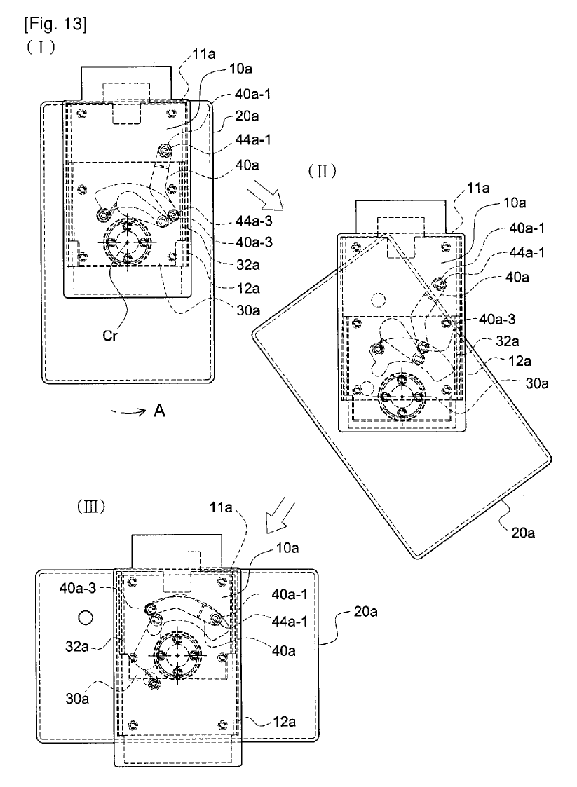

The link 40a is biased toward the pivot direction with reference to a vertical center line Lv′ extending through the pivot center Cr′ when the pivot member 20a is positioned in the longitudinal direction (first position). The link 40a is arranged so that, if the pivot center Cr′ is jointed with both ends of the link 40a (centers of both coupling pins 44a-1 and 44a-2), the resulting triangle has an obtuse angle near the pivot end 40a-3. Particularly, the link 40a is arranged and biased toward the destination of movement of the pivot member 20a from the pivot center Cr′ of the pivot member 20a when the pivot member 20a is in the first position. In addition, the coupling point of the pivot end of the link 40a is positioned across a vertical line, which is parallel with the vertical center line Lv extending through the pivot center Cr′ of the pivot member 20a and which extends through the coupling point of the support member 10a, in a direction opposite to the pivot direction of the link 40a. Thus, the coupling positions of both ends of the link 40a and the pivot angle guarantee first and second sliding movements in the following manner: as the pivot member 20a pivots from the longitudinal direction to the transverse direction, the pivot member 20a initially slides away from the support surface 11a (in a direction opposite to the support surface 11a) so that its corner does not engage with the support surface (first sliding movement). After the corner of the pivot member 20a has moved past the support surface 11a, the pivot member 20a finishes the first sliding movement and begins to slide toward the support surface 11a (second sliding movement). The first and second sliding movements of the link 40a guarantee that, even if the pivot member 20a switches from the longitudinal direction to the transverse direction, it is stably seated and supported on the support surface 11a. The movement trajectory of the link 40a for realizing these movements will be described later in more detail with reference to FIGS. 12-14.

This coupling structure ensures that, as the pivot member 20a pivots, one end of the link 40a coupled to the support member 10a (fixed end) acts as the pivot center, and the other end coupled to the pivot member 20a (pivot end) pivots about the pivot center by a predetermined angle. The length and angle of movement of the link 40a are determined so that the pivot member 20a reaches a desired movement distance after rotating a predetermined angle. According to the present embodiment, the sliding member 30a has an arcuate pivot angle limiting hole 38a formed thereon to limit the angle of rotation of the link 40a so that, when the pivot member 20a pivots relative to the sliding member 30a, it stops pivoting at an angle of 90°. Preferably, the link 40a is bent from the middle of a straight bar shape in a direction opposite to the pivot direction of the link 40a to facilitate the initial movement.

The apparatus has a spring 80a mounted between the support member 10a and the pivot member 20a to multiply operation force during pivot and sliding movements. The spring 80a guarantees that, in the course of the pivot movement of the pivot member 20a caused by external force, the pivot member 20a undergoes extension, compression, and extension again. The restoration force created during the switch from compression to extension is supplied to the pivot member 20a to complete the pivot and sliding movements. Preferably, the coupling positions of both ends of the spring 80a are arranged approximately in the horizontal direction so that, even if the sliding direction is changed, elastic force always acts on the pivot member 20a. Those skilled in the art can easily understand that various types of springs 80a may be used as described with reference to the first embodiment.

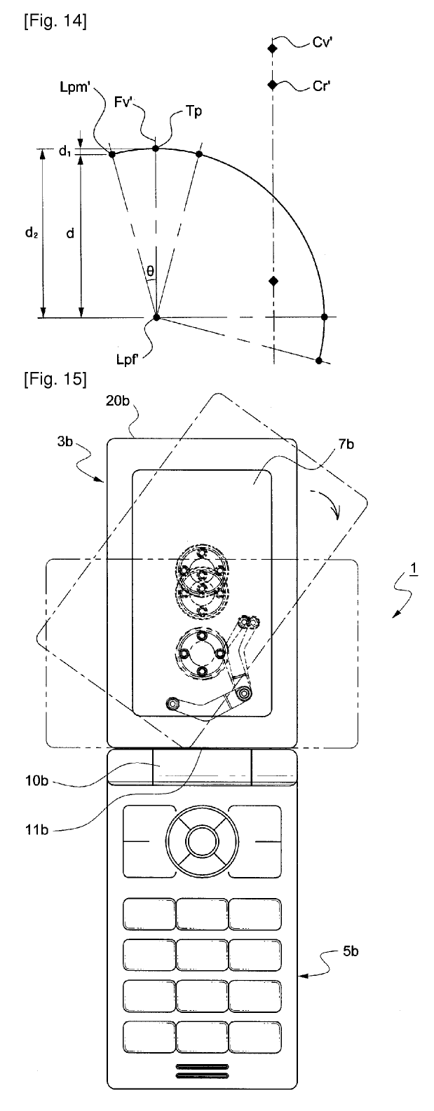

FIG. 12 is a perspective view showing a method for operating and using the apparatus shown in FIGS. 8-11. FIG. 13 shows the operation process of the internal operation mechanism in connection with the method shown in FIG. 12. FIG. 14 shows the movement trajectory of the pivot member and the link during a pivot operation. Particularly, circular dots in FIG. 14 indicate the movement trajectory of the pivot end of the link, and lozenge dots indicate the movement trajectory of the pivot center of the pivot member. The principle of operation according to the second embodiment of the present invention will now be described with reference to these drawings.

The pivot member 20a is initially positioned in the longitudinal direction as shown in (I) of FIG. 12 and in (I) of FIG. 13. If the user rotates the pivot member 20a in direction A, the pivot member 20a, which is coupled to the sliding member 30a by the rotation plate 50a, rotates about the rotation plate 50a. The coupling point Lpf′ of the fixed end 40a-1 of the link 40a, which is coupled to the support member 10a, acts as the center of rotation, and the coupling point Lpm′ of the pivot end 40a-3 coupled to the pivot member 20a rotates about the center of rotation. As a result, the coupling point Lpm′ of the pivot end 40a-3 of the link 40a ascends as much as the distance dl from the initial movement point to the highest point Tp, as shown in FIG. 14. This means that the pivot member 20a, to which the pivot end 40a-3 is coupled, ascends from the support surface 11a. In addition, the guide ledges 32a of the sliding member 30a coupled to the pivot member 20a conduct a first sliding movement along the guide rails 12a of the support members 10a in such a direction that the pivot member 20a is spaced from the support surface 11a. The ascending distance dl to the highest point Tp is set to be the distance of sliding of the corner (inflection point) of the pivot member 20a in the upward direction before it engages with the support surface 11a. In order to realize such a first sliding movement, i.e. in order to guarantee that, in the initial stage of pivot movement of the pivot member 20a from the longitudinal direction to the transverse direction, the pivot member 20a slides away from the support member 10a to prevent the corner from engaging with the support surface 11a, the coupling position of the pivot end 40a-3 when the pivot member 20 is positioned in the longitudinal direction is at a predetermined angle θ from the vertical reference line Fv′ which is parallel with the vertical center line Cv′ extending through the pivot center Cr′ of the pivot member 20a, in a direction opposite to the pivot direction of the link 40a, as shown in FIG. 14. If the coupling position of the pivot end 40a-3 pivots as much as the angle θ relative to the vertical reference line Fv′ it reaches the highest point Tp on the vertical reference line Fv′. Consequently, the pivot member 20a slides upward as much as the ascending distance d1.

After ascending to the highest point Tp, the pivot end 40a-3 of the link 40a descends from the highest point Tp as the pivot member 20a continuously pivots, as shown in FIG. 14. Then, the pivot member 20a descends and slides toward the support surface 11a. As a result, the distance of actual movement of the pivot member 20a, which has pivoted 90° and slid from the staring position to the ending position (hereinafter, referred to as an actual movement distance), corresponds to the distance d obtained by subtracting the ascending distance dl of the link 40a from the descending distance d2. Calculation of the actual movement distance d in this manner makes it possible to slide the pivot member 20a to the desired height while interlocking with the pivot movement. More particularly, if the actual movement distance d is set to be the difference between the transverse and longitudinal lengths of the pivot member 20a from the pivot center Cr′ when the pivot member 20a pivots 90° from the longitudinal direction to the transverse direction according to the present embodiment, the pivot member 20a remains seated on the support surface 11a even after it pivots 90° from the longitudinal direction to the transverse direction as shown in (III) of FIG. 12 and (III) of FIG. 13.

FIG. 15 shows an example of application of the structure according to the second embodiment of the present invention to one of application devices, i.e. a cellular phone.

The structure according to the second embodiment of the present invention, which has been detailed above, can be applied to a folder-type cellular phone, for example, as shown in FIG. 15. Particularly, the structure of the pivot apparatus according to the second embodiment is applied to the cover 3b of the folder-type cellular phone 1b so that, after unfolding the cover 3b from the body 5b, the pivot member 20b provided with a screen 7b may be pivoted relative to the support member 10b of the cover 3b. As a result, the user can watch the screen 7b in either the longitudinal or transverse position.

The application to the cellular phone 1b has the following merits. The pivot member 20b is seated on and is stably coupled to the support surface 11b of the support member 10b of the cover 3b. If the user pivots the pivot member 20b, it ascends away from the support surface 11b while pivoting. After moving past the inflection point, the pivot member 20b descends until it is seated on the support surface 11b of the support member 10b. This guarantees that the pivot member 20b can be used stably in either of the longitudinal and transverse positions, between which it can switch. In other words, when the pivot member 20b provided with a liquid crystal screen 7b switches from the longitudinal view mode to the transverse view mode, it is seated on the support surface 11b of the support member 20b and prevents vibration or other problems of conventional pivot structures while the user watches moving pictures.

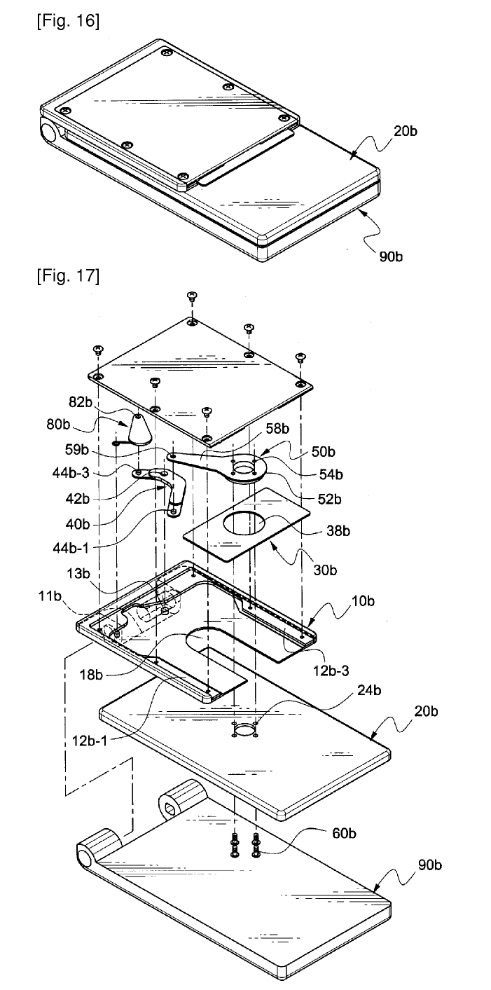

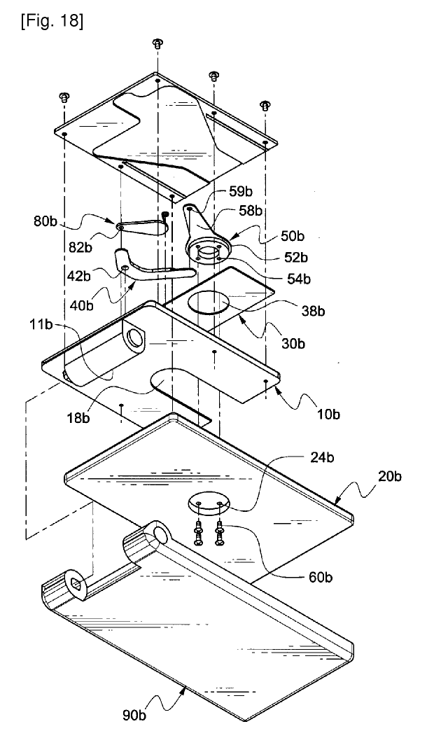

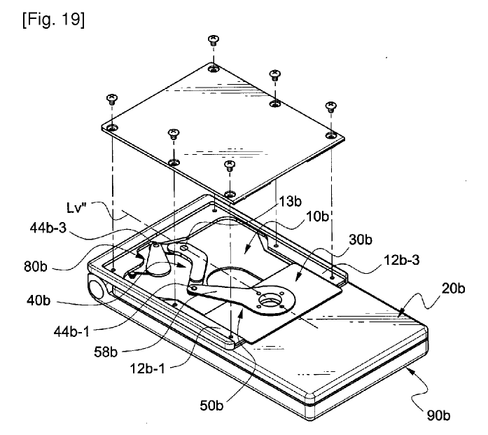

FIG. 16 is an assembled perspective view of a sliding pivot apparatus according to a third embodiment of the present invention. FIG. 17 is an exploded perspective view of the apparatus shown in FIG. 16. FIG. 18 is an exploded perspective view of the apparatus shown in FIG. 17 when viewed from below. FIG. 19 is an assembled perspective view separately showing a part of the apparatus shown in FIG. 16. The third embodiment of the present invention will be described in detail with reference to FIGS. 16-19.

The mechanism of operation of the sliding pivot apparatus according to the third embodiment of the present invention is similar to that according to the second embodiment described above. Particularly, when the pivot member 20b is pivoted from the longitudinal position (first position), it slides upward away from the support surface 11b of the support member 10b by a predetermined distance so that the corner (inflection point) of the pivot member 20b does not interfere with the support surface 11b. After moving past the inflection point, the pivot member 20b changes its sliding direction, i.e. slides downward to the support surface 11b while continuously pivoting. The bottom surface of the pivot member 20b is seated on the support surface 11b when the pivot member 20b is positioned in the transverse direction (second position). As such, the sliding pivot apparatus conducts a series of sliding movements interlocked with the pivot movement. The mechanism of the apparatus for realizing these movements will now be described in more detail.

As shown, the apparatus includes a support member 10b coupled to the body 90b so as to fold on or unfold from the body 90b, and a sliding member 30b slidably coupled to the support member 10b, as in the case of a folder-type cellular phone. To this end, the support member 10b has a pair of guide rails 12b-1 and 12b-3 arranged on the left and right inner sides, and both sides of the sliding member 30b are fitted to the guide rails 12b-1 and 12b-3 and slide along them. As a result of this simple sliding structure, the sliding member 30b slides on the support member 10b, and a pivot member is coupled to the sliding member 30b so that the pivot member 20b can both slide and pivot relative to the support member 10b.

The pivot structure for pivotably coupling the pivot member 20b to the sliding member 30b is as follows: a through-hole 38b is formed on the sliding member 30b, and a rotation plate 50b provided with an engaging ledge 52b is fitted into the through-hole 38b to couple the sliding member 30b to the pivot member 20b. The support member 10b is provided with a passage 18b so that one end of the rotation plate 50b, which extends through the through-hole 38b of the sliding member 30b positioned inside the support member 10b, reaches the pivot member 20b. The length of the passage 18b is determined based on consideration of the sliding distance of the sliding member 30b. As such, one end of the rotation plate 50b extends through the through-hole 38b of the sliding member 30b inside the support member 10b, as well as the passage 18b of the support member 10b, and is forced against the pivot member 20b and fastened/coupled to it by a bolt 60b. For the sake of fastening by the bolt 60b, the pivot member 20b has a bolt hole 24b formed thereon, and the rotation plate 50b has a fastening hole 54b formed on the corresponding end. As a result, a pivot movement of the pivot member 20b is followed by a pivot movement of the rotation plate 50b.

The rotation plate 50b has a connection portion 58b extending from the engaging ledge 52b, which is positioned inside the support member 10b, in a direction perpendicular to the pivot axis. The connection portion 58b is connected to one end of the link 40b, which is rotatably coupled to the support member 10b.

The link 40b is a core component for constraining the pivot member 20b to the support member 10b so that a straight movement occurs according to a pivot movement. One end of the link 40b is spaced from the point, which is rotatably coupled to the support member 10b, and is rotatably coupled to the pivot member 20b. Particularly, the link 40b has a shaft hole 42b formed thereon, into which a shaft pin 13b formed on the support member 10b is fitted and rotatably coupled. The link 40b has coupling pins 44b-1 and 44b-3 on both ends, which are spaced from the shaft hole 42b. The coupling pin 44b-1 on one end is fitted to a pin hole 59b formed on the connection portion 58b of the rotation plate 50b, and the coupling pin 44b-3 on the other end is fitted and coupled to a pin hole 82b of the spring 80b. As such, the rotation plate 50b and the spring 80b are coupled to both ends of the link 40b, respectively, according to the present invention so that, as the pivot member 20b and the link 40b pivot successively, the spring 80b undergoes compression and restoration to provide the link 40b with operation force and multiply the pivot movement force of the pivot member 20b.

As in the case of the second embodiment, the link 40b is biased toward the pivot direction of the pivot member 20b with reference to a vertical center line Lv″ extending through the pivot center of the pivot member 20b when the pivot member 20b is positioned in the longitudinal direction (first position). Particularly, the shaft hole 42b of the link 40b is positioned on the vertical center line Lv″, and the coupling point near the connection portion 58b is biased toward the pivot direction of the pivot member 20b, i.e. opposite to the pivot direction of the link 40b, with reference to the vertical center line Lv″. The coupling position of both ends of the link 40b and the pivot angle guarantee first and second sliding movements in the following manner: as the pivot member 20b pivots from the longitudinal direction to the transverse direction, the pivot member 20b initially slides away from the support surface 11b (in a direction opposite to the support surface 11a) so that its corner does not engage with the support surface 11b (first sliding movement). After the corner of the pivot member 20b has moved past the support surface 11b, the pivot member 20b finishes the first sliding movement and begins to slide toward the support surface 11b (second sliding movement).

This coupling structure guarantees that, as the pivot member 20b pivots, one end (pivot end) of the link 40b, which is coupled to the rotation plate 50b, pivots about a point coupled to the support member 10b by a predetermined angle. Preferably, the link 40b is bent from the middle of a straight bar shape in a direction opposite to the pivot direction of the link 40b to facilitate the initial movement.

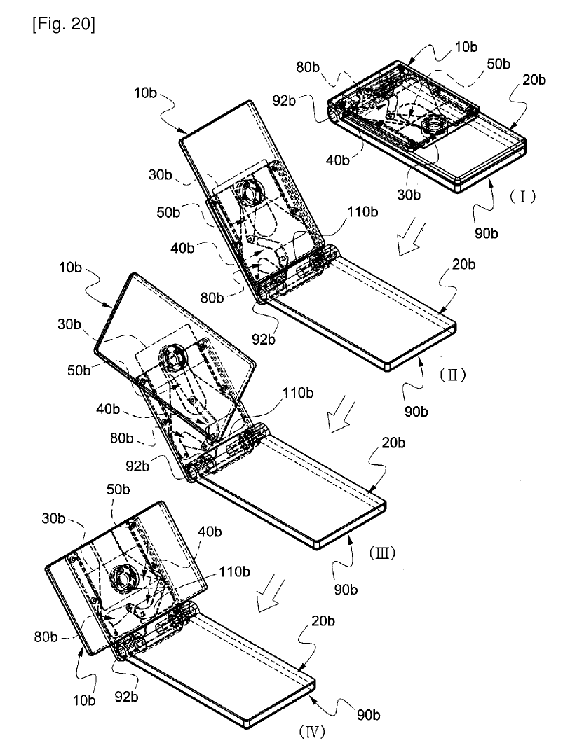

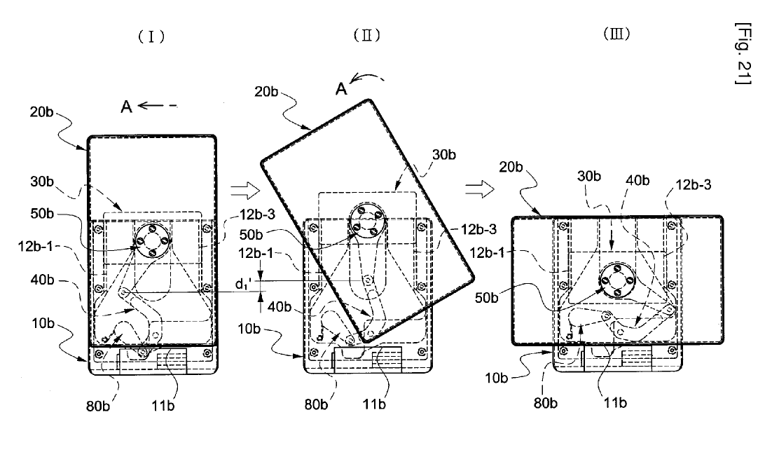

FIG. 20 is a perspective view showing a method for operating and using the apparatus shown in FIGS. 16-19. FIG. 21 is a top view showing the operation mechanism in connection with the method shown in FIG. 20. The operation principle according to the third embodiment of the present invention will be described in detail.

The support member 10b is folded on the body 90b as shown in (I) of FIG. 20. If the support member 10b is lifted, it pivots about the pivot shaft 92b and unfolds from the body 90b with their lateral surfaces abutting each other, as shown in (II) of FIG. 20.

After unfolding the support member 10b from the body 90b, the user pivots the pivot member 20b by hand. Particularly, the pivot member 20b is positioned in the longitudinal direction as shown in (II) of FIG. 20 and in (I) of FIG. 21. The user rotates the pivot member 20b in direction A, and the pivot member 20b and the rotation plate 50b rotate as one. As a result, the link 40b, which is connected to the rotation plate 40b, pivots. Specifically, the pivot end of the link 40b rotates about the point coupled to the support member 10b. Consequently, the link 40b ascends as much as the distance d1′ traveled by the pivot end from the initial movement point to the highest point as shown in (III) of FIG. 20 and in (II) of FIG. 21. This in turn lifts the rotation plate 50b, to which the pivot end is coupled. As a result, the sliding member 30b, to which the rotation plate 50b is fitted, ascends along the guide rails 12b-1 and 12b-3 of the support member 10b. In addition, the pivot member 20b, which is coupled to the sliding member 30b by the rotation plate 50b, slides and ascends away from the support surface 11b (first sliding movement).

After ascending to the highest point, the pivot end of the link 40b descends from the highest point as the pivot member 20b continuously pivots. As a result, the rotation plate 50b connected to the link 40b descends, and the sliding member 30b, to which the rotation plate 50b is coupled, slides toward the support surface 11b (second sliding movement).

After the pivot member 20b has pivoted 90° from the longitudinal direction to the transverse direction, it is seated on the support surface 11b as shown in (IV) of FIG. 20 and in (III) of FIG. 21.

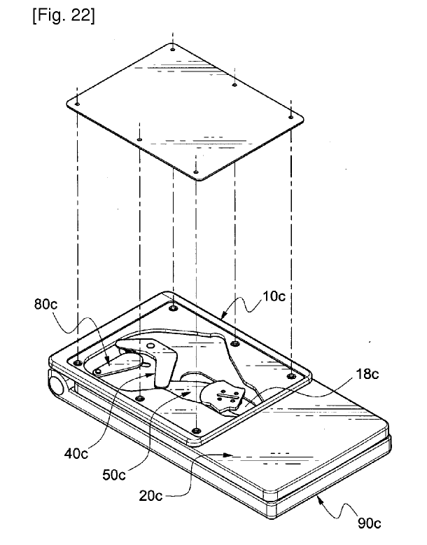

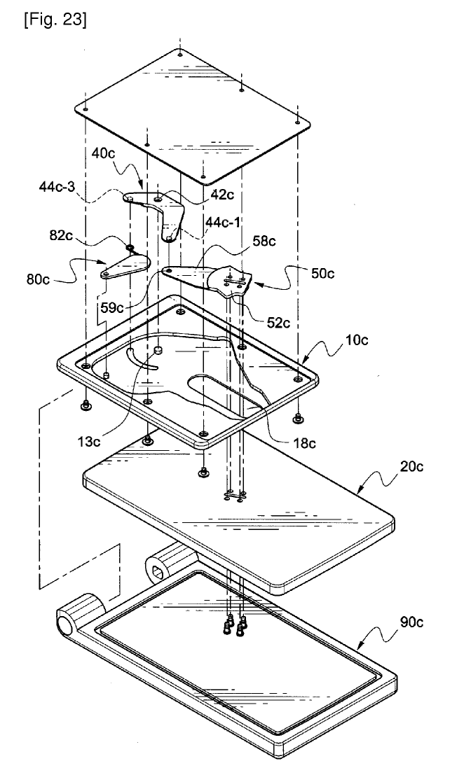

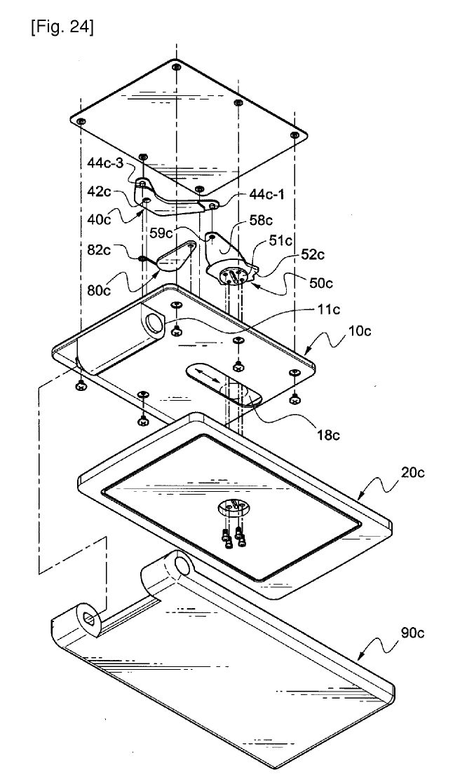

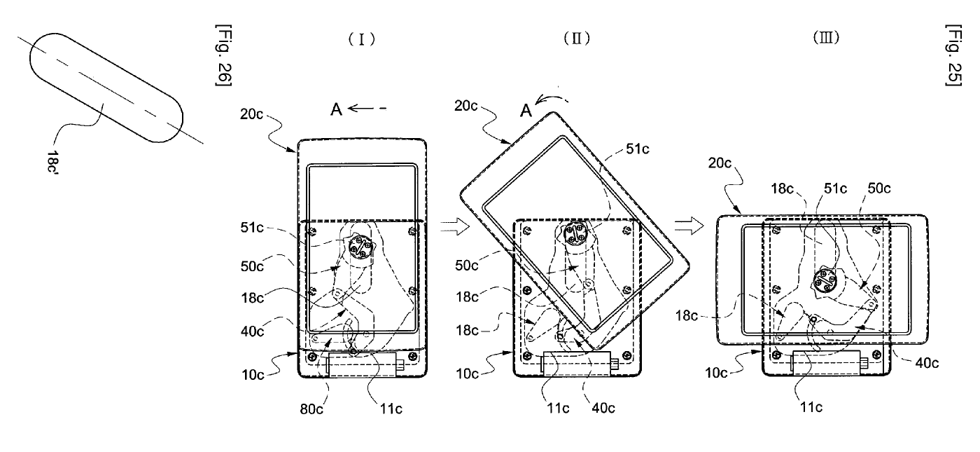

FIG. 22 is an assembled perspective view of a sliding pivot apparatus according to a fourth embodiment of the present invention. FIG. 23 is an exploded perspective view of the apparatus shown in FIG. 22. FIG. 24 is an exploded perspective view of the apparatus shown in FIG. 23 when viewed from below. FIG. 25 shows a method for operating and using the apparatus shown in FIGS. 22-24.

The construction and operation mechanism of the sliding pivot apparatus according to the fourth embodiment of the present invention are similar to those of the third embodiment described above, except that the sliding member according to the third embodiment is omitted, and that the rotation plate 50c has an insertion portion 51c having a width slightly smaller than that of the passage 18c of the support member 10c so that the insertion portion 51c is press-fitted to the passage 18c according to the fourth embodiment. As a result, the insertion portion 51c does not play in the direction of the width of the passage 18c, but moves only in the longitudinal direction (sliding direction) and guides the sliding movement of the sliding member 20c. The insertion portion 51c of the rotation plate 50c has a circular shape, and can both slide and rotate in the passage 18c. As such, when the rotation plate 50c is fitted into the passage 18c, the ledge 52c of the rotation plate 50c engages with the passage 18c, and the circular insertion portion 51c is fitted into the passage 18c and is guided to slide straightly along the passage 18c. The passage 18c is an elongated hole extending along the sliding direction with both ends closed.

The link 40c is coupled to the connection portion 58c of the rotation plate 50c, and the coupling structure and operation of the link 40c are the same as has been described with reference to FIG. 3. Particularly, the link 40c has a shaft hole 42c, into which a shaft pin 13c formed on the support member 10c is fitted and rotatably coupled. The link 40c has coupling pins 44c-1 and 44c-3 on both ends spaced from the shaft hole 42c. The coupling pin 44c-1 on one end is fitted into a pin hole 59c formed on the connection portion 58c of the rotation plate 50c, and the coupling pin 44c-3 on the other end is fitted and coupled to a pin hole 82c of the spring 80c. As such, the rotation plate 50c and the spring 80c are coupled to both ends of the links 40c, respectively, according to the present embodiment so that, as the pivot member 20c and the link 40c pivot successively, the spring 80c undergoes compression and restoration, provides the link 40c with operation force, and multiplies the pivot movement force of the pivot member 20c.

The link 40c, which has the same coupling structure and operation as has been described with reference to the third embodiment, is adapted for first and second sliding movements in the following manner: when the pivot member 20c pivots from the longitudinal direction to the transverse direction, the pivot member 20c slides away from the support surface 11c so that the corner of the pivot member 20c does not interfere with the support surface 11c (first sliding movement). After the corner of the pivot member 20c has moved past the support surface 11c, the pivot member 20c finishes the first sliding movement and slides toward the support surface 11c (second sliding movement). Refer to the above description of the third embodiment for further details.

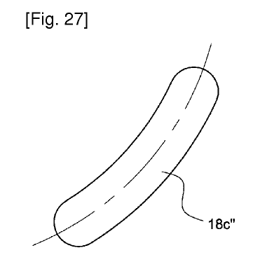

FIGS. 26 and 27 show examples of passages formed on the support member in the sliding direction according to embodiments of the present invention. The passage 18c′ may slightly deviate from the straight line parallel with the sliding direction as exemplified above. Particularly, the passage 18c′ may be slanted slightly relative to the straight line parallel with the sliding direction, as shown in FIG. 26. Alternatively, the slanted passage shown in FIG. 26 may be curved to form a curved passage 18c″ and facilitate smoother movement, as shown in FIG. 27. By slanting the passage from the straight line parallel with the sliding direction in this manner, the rotation plate, which moves along the passage, can begin pivoting smoothly and efficiently in a stationary condition.

### INDUSTRIAL APPLICABILITY

Although several exemplary embodiments of the present invention have been described for illustrative purposes, those skilled in the art will appreciate that various modifications, additions and substitutions are possible, without departing from the scope and spirit of the invention as disclosed in the accompanying claims. For example, the pivot structure and link of the inventive apparatus may be combined with a sliding structure of any structure or type as long as a straight sliding movement can be provided. In addition, although the present invention has been described with regard to a cellular phone as its application object, the present invention is not limited to cellular phones and is applicable to other application devices having a support body and a pivot body, which are supposed to undergo pivot and straight movements relative to each other.

1. A sliding pivot apparatus comprising:
a support member;
a sliding member slidably coupled to the support member;
a pivot member pivotably coupled to the sliding member; and
a link having a first end rotatably coupled to the pivot member and a second end rotatably coupled to the support member so that, as the pivot member pivots, the first end coupled to the pivot member pivots about a point coupled to the support member and displaces the pivot member.

2. The sliding pivot apparatus as claimed in claim 1, wherein a through-hole is formed on the pivot member, and a rotation plate having an engaging ledge is fitted into the through-hole to couple a first end of the rotation plate to the sliding member so that the pivot member and the sliding member are pivotably coupled to each other.

3. The sliding pivot apparatus as claimed in claim 2, wherein a lubricating member is fitted to the rotation plate and interposed between the pivot member and the sliding member to reduce pivot friction.

4. The sliding pivot apparatus as claimed in claim 1, wherein, when the pivot member is positioned in a longitudinal direction, the link is biased toward a destination of movement of the pivot member from a pivot center of the pivot member, and the pivot center of the pivot member and both ends of the link constitute an obtuse triangle.

5. A sliding pivot apparatus comprising:
a support member;
a sliding member slidably coupled to the support member;
a pivot member having a through-hole;
a rotation plate having a first end coupled to the sliding member via the through-hole and a second end provided with an engaging ledge for engaging with a periphery of the through-hole of the pivot member so that the pivot member and the sliding member are pivotably coupled to each other; and
a link having a first end rotatably coupled to the pivot member and a second end rotatably coupled to the support member so that, as the pivot member pivots, a pivot end coupled to the pivot member pivots about a point coupled to the support member and displaces the pivot member in a direction.

6. The sliding pivot apparatus as claimed in claim 5, wherein, when the pivot member is positioned in a longitudinal direction, the link is biased toward a destination of movement of the pivot member from a pivot center of the pivot member and is positioned in a half region in a pivot direction of the pivot member with reference to a vertical center line extending through the pivot center of the pivot member.

7. The sliding pivot apparatus as claimed in claim 5, wherein the pivot member has a rectangular shape with different longitudinal and transverse ratios, the pivot member is adapted to reciprocate between a first position in a longitudinal direction and a second position in a transverse direction while conducting interlocked pivot and sliding movements, a line segment leading from the pivot center to the pivot end of the link is joined with a line segment leading from the pivot end to the fixed end of the pivot member at an obtuse angle in the first position, and the obtuse angle is gradually decreased by a pivot movement of the pivot member from the first position to the second position.

8. The sliding pivot apparatus as claimed in claim 7, wherein the support member comprises a front plate portion, a rear plate portion spaced from the front plate portion, and a connection portion connecting the front and rear plate portions so that a receiving space is defined between the front and rear plate portions and that the pivot member and the sliding member are positioned in the receiving space, and the connection portion has an inner surface forming a support surface for supporting a lateral surface of the pivot member.

9. The sliding pivot apparatus as claimed in claim 5, further comprising a spring installed between the support member and the sliding member and adapted to undergo extension, compression, and extension again in the course of the pivot movement caused by external force so that the spring provides the sliding member with restoration force obtained during conversion from compression to extension and completes the sliding movement of the sliding member and the pivot movement of the pivot member.

10. The sliding pivot apparatus as claimed in claim 9, wherein the support member has a pair of guide holes formed on both sides, respectively, and the sliding member has engaging ledges for engaging with the corresponding guide holes and sliding along the guide holes, respectively.

11. A sliding pivot apparatus comprising:
a support member;
a sliding member slidably coupled to the support member;
a pivot member having a through-hole;
a rotation plate having a first end coupled to the sliding member via the through-hole and a second end provided with an engaging ledge for engaging with a periphery of the through-hole of the pivot member so that the pivot member and the sliding member are pivotably coupled to each other; and
a link having a first end rotatably coupled to the pivot member and a second end rotatably coupled to the support member so that, as the pivot member pivots, a pivot end coupled to the pivot member pivots about a point coupled to the support member in a direction opposite to a pivot direction of the pivot member to displace the pivot member in a direction and, after a change of direction, displaces the pivot member in the opposite direction.

12. The sliding pivot apparatus as claimed in claim 11, wherein the sliding member has an arcuate pivot angle limiting hole for limiting rotation of the pivot end of the link so that the pivot member pivots up to 90°, and the pivot end of the link is coupled to the pivot member via the pivot angle limiting hole by a coupling pin.

13. The sliding pivot apparatus as claimed in claim 11, further comprising a spring installed between the support member and the sliding member and adapted to undergo extension, compression, and extension again in the course of the pivot movement caused by external force so that the spring provides the pivot member with restoration force obtained during conversion from compression to extension and completes the pivot movement and the sliding movement.

14. The sliding pivot apparatus as claimed in claim 13, wherein the support member has a pair of guide rails on both sides, respectively, and the sliding member has engaging ledges for engaging with the corresponding guide rails and sliding along the guide rails, respectively.

15. The sliding pivot apparatus as claimed in claim 14, wherein lubricating members are interposed between the rotation plate and the pivot member and between contacting portions of the pivot member and the sliding member, respectively.

16. A sliding pivot apparatus comprising:
a support member;
a sliding member slidably coupled to the support member and provided with a through-hole;
a rotation plate having a first end coupled to the pivot member via the through-hole and a second end provided with an engaging ledge for engaging with a periphery of the through-hole of the sliding member so that the pivot member and the sliding member are pivotably coupled to each other;
a pivot member coupled to the first end of the rotation plate and adapted to slide while rotating as an integral unit with the rotation plate; and
a link having a first end rotatably coupled to the rotation plate and a second end rotatably coupled to the support member so that, as the pivot member pivots, a pivot end coupled to the pivot member pivots about a point coupled to the support member in a direction opposite to a pivot direction of the pivot member to slide the sliding member in a direction and, after a change of direction, slides the sliding member in the opposite direction.

17. A sliding pivot apparatus comprising:
a support member having a passage formed in a sliding direction of the pivot member;
a rotation plate having a circular insertion portion formed on a first end, the circular insertion portion being coupled to the pivot member via the passage, and an engaging ledge formed on a second end to engage with a periphery of the passage of the support member so that the pivot member and the support member are pivotably coupled to each other;
a pivot member coupled to the first end of the rotation plate and adapted to slide while rotating as an integral unit with the rotation plate; and
a link having a first end rotatably coupled to the rotation plate and a second end rotatably coupled to the support member so that, as the pivot member pivots, a pivot end coupled to the pivot member pivots about a point coupled to the support member in a direction opposite to a pivot direction of the pivot member to slide the pivot member in a direction and, after a change of direction, slides the pivot member in the opposite direction.

18. The sliding pivot apparatus as claimed in claim 17, wherein the circular insertion portion of the rotation plate has a diameter slightly smaller than the width of the passage so that the circular insertion portion slide along the passage in the longitudinal direction of the passage without vibrating in the transverse direction of the passage.

19. The sliding pivot apparatus as claimed in claim 17, wherein the passage extends along a line selected from a straight line parallel with the sliding direction and a slanted line or a curved line slightly slanted from the straight line parallel with the sliding direction.

20. The sliding pivot apparatus as claimed in claim 16, wherein the rotation plate has a connection portion extending from the engaging ledge and is link-coupled to the pivot end of the link.

21. The sliding pivot apparatus as claimed in claim 20, wherein the link additionally extends from a pivot center point coupled to the support member in a direction opposite to the direction of connection to the rotation plate, a spring is installed between the extending portion and the support member and is adapted to undergo extension, compression, and extension again in the course of the pivot movement of the link so that the spring provides the link with restoration force obtained during conversion from compression to extension.

22. The sliding pivot apparatus as claimed in claim 11, wherein the pivot member has a rectangular shape with different transverse and longitudinal ratios and is adapted to reciprocate between a first position in a longitudinal direction and a second position in a transverse direction while conducting interlocked pivot and sliding movements, the link is biased toward a destination of movement of the pivot member from the pivot center of the pivot member when the pivot member is in the first position, and the pivot end of the link is positioned past a vertical line extending through the coupling point of the support member in parallel with a vertical center line extending through the pivot center of the pivot member in a direction opposite to the pivot direction of the link.

23. The sliding pivot apparatus as claimed in claim 22, wherein the link is positioned in a half region in a direction opposite to the pivot direction of the pivot member with reference to the vertical center line extending through the pivot center of the pivot member in the first position, and the pivot center of the pivot member and the fixed and pivot ends of the link constitute a triangle having an obtuse angle corresponding to the pivot end.

24. The sliding pivot apparatus as claimed in claim 23, wherein the link has a straight bar shape with the pivot end being bent in a direction opposite to the pivot direction of the link.

25. The sliding pivot apparatus as claimed in claim 1, wherein the sliding pivot apparatus is applied to one of a cellular phone, a PDA, and an LCD monitor.

26. The sliding pivot apparatus as claimed in claim 6, wherein the pivot member has a rectangular shape with different longitudinal and transverse ratios, the pivot member is adapted to reciprocate between a first position in a longitudinal direction and a second position in a transverse direction while conducting interlocked pivot and sliding movements, a line segment leading from the pivot center to the pivot end of the link is joined with a line segment leading from the pivot end to the fixed end of the pivot member at an obtuse angle in the first position, and the obtuse angle is gradually decreased by a pivot movement of the pivot member from the first position to the second position.

27. The sliding pivot apparatus as claimed in claim 26, wherein the support member comprises a front plate portion, a rear plate portion spaced from the front plate portion, and a connection portion connecting the front and rear plate portions so that a receiving space is defined between the front and rear plate portions and that the pivot member and the sliding member are positioned in the receiving space, and the connection portion has an inner surface forming a support surface for supporting a lateral surface of the pivot member.

28. The sliding pivot apparatus as claimed in claim 18, wherein the passage extends along a line selected from a straight line parallel with the sliding direction and a slanted line or a curved line slightly slanted from the straight line parallel with the sliding direction.

29. The sliding pivot apparatus as claimed in claim 17, wherein the rotation plate has a connection portion extending from the engaging ledge and is link-coupled to the pivot end of the link.

30. The sliding pivot apparatus as claimed in claim 29, wherein the link additionally extends from a pivot center point coupled to the support member in a direction opposite to the direction of connection to the rotation plate, a spring is installed between the extending portion and the support member and is adapted to undergo extension, compression, and extension again in the course of the pivot movement of the link so that the spring provides the link with restoration force obtained during conversion from compression to extension.

31. The sliding pivot apparatus as claimed in claim 16, wherein the pivot member has a rectangular shape with different transverse and longitudinal ratios and is adapted to reciprocate between a first position in a longitudinal direction and a second position in a transverse direction while conducting interlocked pivot and sliding movements, the link is biased toward a destination of movement of the pivot member from the pivot center of the pivot member when the pivot member is in the first position, and the pivot end of the link is positioned past a vertical line extending through the coupling point of the support member in parallel with a vertical center line extending through the pivot center of the pivot member in a direction opposite to the pivot direction of the link.

32. The sliding pivot apparatus as claimed in claim 17, wherein the pivot member has a rectangular shape with different transverse and longitudinal ratios and is adapted to reciprocate between a first position in a longitudinal direction and a second position in a transverse direction while conducting interlocked pivot and sliding movements, the link is biased toward a destination of movement of the pivot member from the pivot center of the pivot member when the pivot member is in the first position, and the pivot end of the link is positioned past a vertical line extending through the coupling point of the support member in parallel with a vertical center line extending through the pivot center of the pivot member in a direction opposite to the pivot direction of the link.

33. The sliding pivot apparatus as claimed in claim 31, wherein the link is positioned in a half region in a direction opposite to the pivot direction of the pivot member with reference to the vertical center line extending through the pivot center of the pivot member in the first position, and the pivot center of the pivot member and the fixed and pivot ends of the link constitute a triangle having an obtuse angle corresponding to the pivot end.

34. The sliding pivot apparatus as claimed in claim 32, wherein the link is positioned in a half region in a direction opposite to the pivot direction of the pivot member with reference to the vertical center line extending through the pivot center of the pivot member in the first position, and the pivot center of the pivot member and the fixed and pivot ends of the link constitute a triangle having an obtuse angle corresponding to the pivot end.

35. The sliding pivot apparatus as claimed in claim 33, wherein the link has a straight bar shape with the pivot end being bent in a direction opposite to the pivot direction of the link.

36. The sliding pivot apparatus as claimed in claim 34, wherein the link has a straight bar shape with the pivot end being bent in a direction opposite to the pivot direction of the link.

37. The sliding pivot apparatus as claimed in claim 5, wherein the sliding pivot apparatus is applied to one of a cellular phone, a PDA, and an LCD monitor.

38. The sliding pivot apparatus as claimed in claim 11, wherein the sliding pivot apparatus is applied to one of a cellular phone, a PDA, and an LCD monitor.

39. The sliding pivot apparatus as claimed in claim 16, wherein the sliding pivot apparatus is applied to one of a cellular phone, a PDA, and an LCD monitor.

40. The sliding pivot apparatus as claimed in claim 17, wherein the sliding pivot apparatus is applied to one of a cellular phone, a PDA, and an LCD monitor.
